(19) United States
(12) Patent Application Publication
(10) Pub. No.: US 2002/0124253 A1
(43) Pub. Date: Sep. 5, 2002

(54) Personal information database with privacy for targeted advertising

(76) Inventors: Mark Kenneth Eyer, San Diego, CA (US); Matthew S. Chang, San Diego, CA (US); Aditya Krishnan, San Diego, CA (US); Andrew M. Proehl, San Francisco, CA (US); David K. L. Yang, San Jose, CA (US); Fred J. Zustak, Poway, CA (US); Peter Rae Shintani, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/798,821

(22) Filed: Mar. 2, 2001

(51) Int. Cl. H04N 7/10; H04N 7/173

(52) U.S. Cl. 725/34; 725/134

(57) ABSTRACT

An information network, such an interactive set-top box, is provided to enable user to receive targeted information through use of a personal information database. Through interaction with the set-top box, the user may establish a personal profile database that specifies his or her interests, preferences and other information. This information is communicated to a service provider. Based on this information, the service provider builds a personal information database and creates customized and directed advertising targeted to that user. The customized advertising may be download to the user's multimedia storage device (either within the set-top box or external to it). The user information may also be passed to vendors, but the user's identity is withheld, thereby ensuring the privacy of the user.

### CROSS REFERENCE TO RELATED APPLICATIONS

This application is related to and claims benefit under 35 U.S.C. §120 of U.S. patent application Ser. No. 09/752,632, filed Jan. 2, 2001 to the same inventors as the present application entitled “User Selective Advertising”, Docket No. SNY-P4146 and to U.S. patent application Ser. No. 09/752,968, filed Jan. 2, 2001 to the same inventors as the present application entitled “Targeted Advertising During Playback of Stored Content”, Docket No. SNY-P4164. These applications are hereby incorporated by reference as though disclosed fully herein.

### FIELD OF THE INVENTION

This invention relates generally to the distribution of targeted advertisements or other video programming to the home via cable, satellite or terrestrial television.

### BACKGROUND OF THE INVENTION

Conventional television is a mixture of broadcast programming and advertisements. Demographic targeting of advertisements is currently achieved by placing advertisements in broadcast programs matched to the programs' target audience. Programs with large, well-defined, audiences command the highest prices for advertising time. There are several disadvantages to the current approach. Firstly, advertising time within popular programs is very limited and the resulting cost to advertisers is thus very high. Secondly, the viewers receive some advertisements that may be of no interest to them.

U.S. Pat. No. 5,155,591 to Wachob describes a method and apparatus for providing demographically targeted television commercials. This system is shown FIG. 1. The TV service provider 2 broadcasts different commercial messages to different demographically targeted audiences in a cable television system or the like. A group of television channels 4 contains television programs and periodic commercial messages. An additional channel 6 contains alternate commercial messages. The program channel to be viewed is chosen according to the viewer operated channel selector 8. Demographic characteristics of a viewer are identified, and commercial messages are selectively provided from the program channel or the additional channel according to demographic switch 10 depending upon the viewer's demographic characteristics. The switch control 12 is determined by demographic data which can be input by a viewer via user input 12, such as a remote control, downloaded to a subscriber's converter from a remote head end via switch command link 16 or programmed into the converter at installation. The advertisements are viewed on television display 18. This system makes inefficient use of the broadcast bandwidth, since all advertisements are sent to the user. Also, it doesn't provide for communication from the user to the TV service provider.

U.S. Pat. No. 6,020,883 to Herz et al. describes a system and method for scheduling broadcast of and access to video programs and other data using customer profiles. The Herz et al. patent provides an optimized mix of broadcast programming for the benefit of the viewer, but does not address the problem of targeting advertisements. The viewer still has no control of the advertisement being sent, and the advertiser has no guarantee that the user will be interested in receiving his advertisement.

### SUMMARY OF THE INVENTION

Certain embodiments of the invention provide a mechanism for a television viewer to be able to receive advertisements that match his or her interests or needs.

Certain embodiments also provide a television broadcaster with a mechanism to identify the interests and needs of a television viewer and, thereby, to provide the viewer with advertisements matched to his or her interests or needs.

According to certain embodiments of the present invention, an information network, such an interactive set-top box, is provided. Through interaction with the set-top box, the user may establish a personal information database (user profile) that specifies his or her interests, preferences and other information. This information is communicated to the television service provider. Based on this information, the television service provider creates customized and directed advertising targeted to that user, as well as other information, such as Internet addresses, that may be of particular interest. The customized advertising may be downloaded to the user's multimedia storage device (either within the set-top box or external to it). The set-top box may be configured to display the downloaded advertising as an additional television channel, which can be selected by the user. The set-top box may be configured so that when the user is viewing the regular broadcast channels, the stored advertisements are viewed in place of the regularly transmitted advertisements.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a block diagram of a prior art system for demographic filtering of advertisements.

FIG. 2 is a block diagram of an exemplary system of the present invention.

FIG. 3 shows a system configuration for a digital set-top box suitable for use in the present invention.

### DESCRIPTION OF THE INVENTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

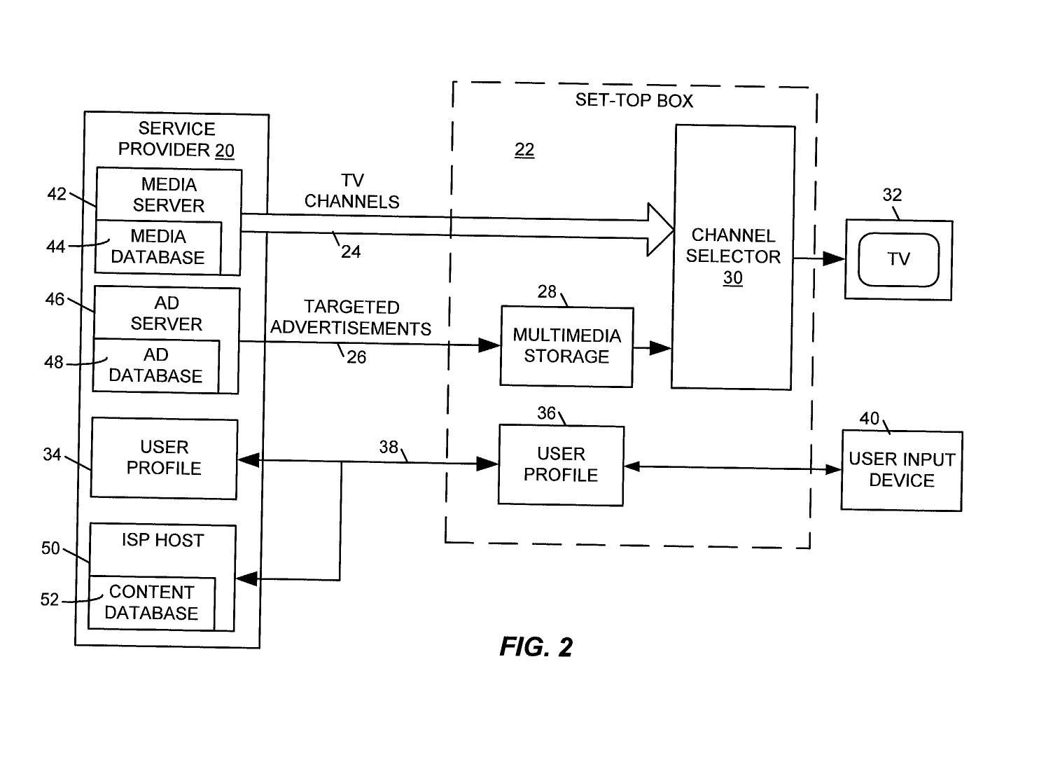

Referring to FIG. 2, a block diagram of an exemplary system of the current invention is shown. The head end of television (TV) service provider 20 includes a media server 42 with media database 44, which supplies television program channels over television transmission medium 24 to a viewer's set-top box (STB) 22. The transmission medium 24 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 24 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. The head end of television (TV) service provider 20 also includes an advertisement (AD) server 46, with AD database 48, which supplies additional targeted advertisements to the set-top box 22 over link 26. Here, advertisements are taken to include targeted information, such as product descriptions and pricing, promotional material or supplier information. Link 26 may be the same physical link as 24 or may be a separate communications link. The targeted advertisements are stored in multimedia storage device 28, which may be physically located within the set-top box 22 or connected to the set-top box via a data interface. The viewer may use channel selector 30 to select between conventional TV channels or the targeted advertisements stored on multimedia storage device 28. The selected channel is displayed on television display 32. This may be a digital television or other audio visual display device.

The TV service provider 20 selects the targeted advertisement to be transmitted over link 26 according to a remote personal information database (user profile) 34 stored at the TV service provider's head end. This remote user profile 34 contains information related to, for example, the viewers stated preferences, leisure and professional interests, specific products interests and personal information. The remote user profile 34 may contain information related to the user's viewing habits or, with the viewer's permission, spending habits.

The viewer's stated profile is obtained by downloading data from the user's local user profile 36, which is stored in the set-top box. The information is transmitted across link 38. In the case of a cable STB 22, the link 38 may be included in transmission medium 24, and the set-top box 22 can generally provide for bidirectional communication over the transmission medium 24. In other embodiments, link 38 can be effected using asymmetrical communication techniques possibly using dual communication media—one for the uplink and one for the downlink. In other embodiments, the link 38 can be effected using a telephone line and a dial-up modem or a digital subscriber line (DSL). In any event, the STB 22 can have its own Universal Resource Locator (URL) or IP address or other unique identifier assigned thereto to provide for addressability by the head end and users of the Internet.

The STB 22 may also be coupled to an independent service provider (ISP) host 50 by a suitable connection including dial-up connections, DSL (Digital Subscriber Line) or the same communications link 38 described above (e.g., using a cable modem) to, thus, provide access to services and content from the ISP and the Internet. The ISP host 50 provides various content to the user that is obtained from a content database 52. STB 22 may also be used as an Internet access device to obtain information and content from remote servers via the Internet using host 50 operating as an Internet portal, for example. In certain satellite STB environments, the data can be downloaded at very high speed from a satellite link, with asymmetrical upload speed from the set-top box provided via a dial-up or DSL connection.

The service provider may supply information to vendors via the Internet. For example, if a user has an interest in a particular product, he may enter the product description into his local user profile. This is information is transferred to his remote user profile as a specific product request. The service provider may send this information to vendors or may make it available in a searchable database on the service provider's web site. A vendor may respond with information that can be passed on to the user. An important feature of this service is that the user's identity is not passed onto the vendor. This feature may be important in encouraging user's to adopt the service. The service provider may charge a fee from the vendor.

This mode of operation is in contrast to conventional advertising, where the delivery of the advertisement is instigated by the advertiser rather than by the customer.

The user may update the information in his or her local user profile by interacting with the set-top box 22 using user input device 40. The input device may be an infrared or other wireless remote control, keyboard, personal digital assistant, laptop computer, keyboard or computer mouse for example. In addition, an input device in the form of a control panel located on the TV 32 or the STB 22 can be provided.

The STB 22 may be coupled to the TV 32 and various other audio/visual devices (such as audio systems, Personal Video Recorders (PVRs), Video Tape Recorders (VTRs), Video Cassette Recorders (VCRs) and the like), storage devices (e.g., hard disc drives) and Internet Appliances (such as email devices, home appliances, storage devices, network devices, and other Internet Enabled Appliances) by an appropriate interface, which can be any suitable analog or digital interface. In one embodiment, the interface conforms to an interface standard, such as the Institute of Electrical and Electronics Engineers (IEEE) 1394 standard, but could also be wholly or partially supported by a DVI interface (Digital Visual Interface-Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 24. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 32 itself, thus eliminating the STB 22. Further, a computer having a tuner device and modem may be equivalently substituted for the TV 32 and STB 22.

By way of example, the STB 22 may be coupled to devices such as a personal computer, video cassette recorder, camcorder, digital camera, personal digital assistant and other audio/visual or Internet related devices. In addition, a data transport architecture may be utilized to enable interoperability among devices on a network regardless of the manufacturer of the device if manufacturers agree to adhere to an industry standard. The STB 22 runs an operating system suitable for a home network system.

Those skilled in the art will appreciate that the illustration of FIG. 2 represents a simplified depiction of a cable system configuration shown simply as service provider 20. The actual configuration of the service provider's equipment is more likely to follow a configuration defined by the CableLabs OpenCable™ specification. The simplified illustration shown is intended to simplify the discussion of the operation of service provider 20 without unnecessarily burdening the discussion with architectural details that will be evident to those skilled in the art. Many of those details can be found in the publicly available CableLabs OpenCable™ specification or in the text “OpenCable Architecture (Fundamentals)” by Michael Adams, Cisco Press, November 1999.

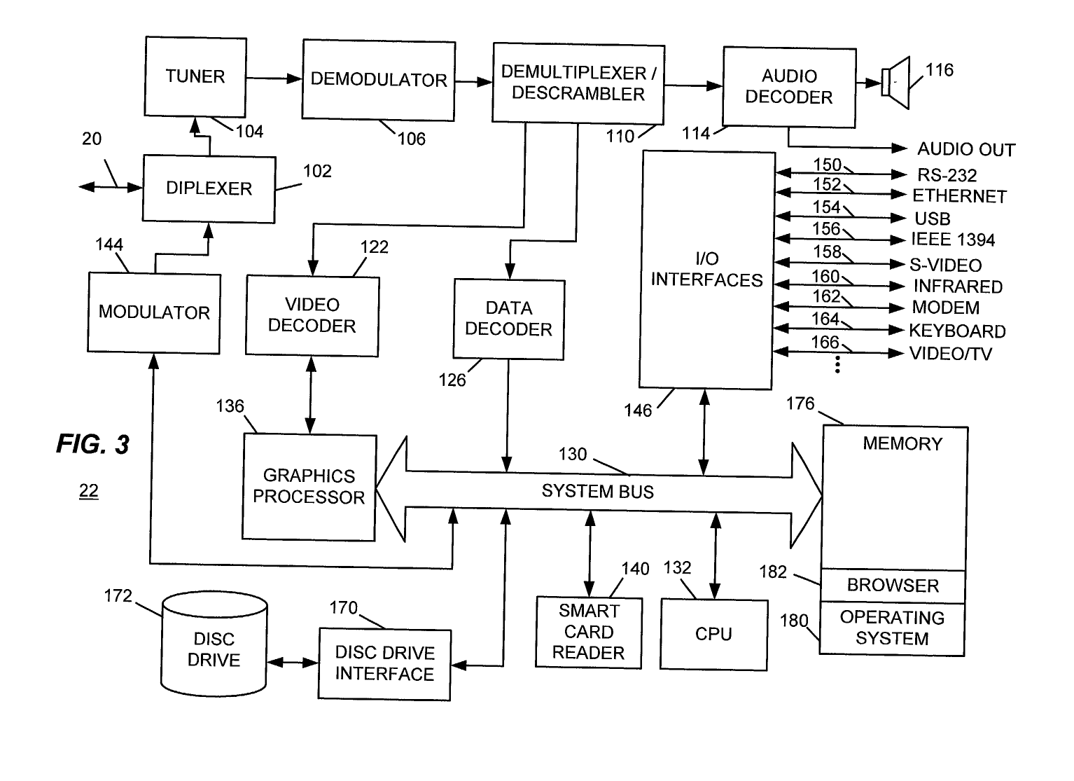

Referring now to FIG. 3, a system configuration for a digital set-top box 22, in accordance with the present invention, is illustrated. In this exemplary set-top box, the transmission medium 24, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. In the case where links 24 and 26 are combined, the targeted advertisements transmitted on link 26 may be encoded as in-band (TV) or OOB (data) signals.

A return path through diplexer 102 provides an OOB return path for outbound data (destined, for example, for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also descrambles scrambled information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

In the case where links 24 and 26 are combined, decoded data or video packets representing targeted advertising are sent via the system bus 130 to an appropriate storage device, such as hard disc drive 172, or via an I/O interface 146 to an external storage device.

In the case of analog TV signals (not shown), there may be one tuner for selecting TV channels and a second tuner for the targeted advertisement channel(s). The targeted advertisements are sent to a multimedia recorder for storage. When the user selects the advertisement channel, the output from the multimedia recorder is displayed on the television.

Referring again to FIG. 3, decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so-called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 24. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called Firewire™ or i-LINK™) or IEEE 1394 port 156, S-video port 158 or infrared port 160. Such interfaces can be utilized to interconnect the STB 22 with any of a variety of accessory devices such as storage devices, audio/visual devices, gaming devices (not shown), Internet Appliances, etc.

I/O interfaces 146 can include a modem (be it dial-up, cable, DSL or other technology modem) having a modem port 162 to facilitate high speed or alternative access to the Internet or other data communication functions, such as link 38 described above. In one preferred embodiment, modem port 162 is that of a DOCSIS (Data Over Cable System Interface Specification) cable modem to facilitate high-speed network access over a cable system, and port 162 is appropriately coupled to the transmission medium 24 embodied as a coaxial cable. Thus, the STB 22 can carry out bidirectional communication via the DOCSIS cable modem with the STB 22 being identified by a unique IP address. The DOCSIS specification is publically available. Of course, it is envisioned that the modem can be built into the set-top box. An external modem may not be needed if there is adequate upstream capability.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 32 instead of (or in addition to) an IEEE 1394 connection. In one embodiment, Video output 166 can provide composite video formatted as NTSC (National Television System Committee) video.

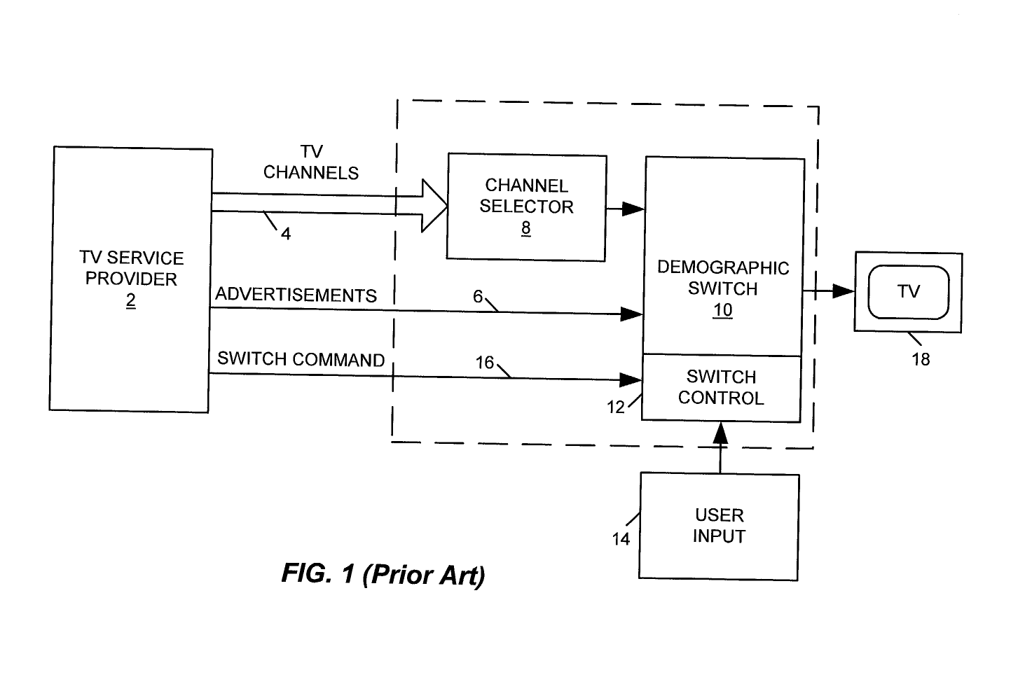

The infrared port 160 can be embodied as an infrared receiver to receive commands from an infrared remote control, infrared keyboard or other infrared control device illustrated as 40 in FIG. 1. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. The local user profile, illustrated as 36 in FIG. 1, may be stored on the disc drive 172. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security, and a separate video path. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or browser software may permanently reside in ROM, EEPROM or Flash memory, for example. The browser software 182 may operate as the mechanism for viewing not only web pages on the Internet, and can serve as the mechanism for viewing an Electronic Program Guide (EPG) formatted as an HTML document. The user may input data to the local user profile, illustrated as 36 in FIG. 2, by entering data into an HTML questionnaire viewed using browser 182.

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside, e.g., browsing, email, EPG, Video On Demand (VOD), rich multimedia applications, pay per view, etc. The current invention can be utilized with any suitable set-top box software and hardware architecture.

In addition to providing targeted advertising to the user, the service provider may also act as a selling agent for vendors. In one embodiment, the user's purchase requests may be received over communications link 38. Confirmation of orders may also be provided to the user using this link. The purchasing history of the user may be included in the user profile stored by the service provider.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A system enabling a user to receive targeted information from a remote service provider, said system comprising:
a memory element operable to store a personal information database of information related to the user;
a first output element, operably connected to said memory element, operable to transmit the targeted information from said personal information database to said remote service provider;
a first input element operable to receive the targeted information from said remote service provider;
a multimedia storage element, operably connected to said first input element, operable to store said targeted information; and
a second output element operable to transmit the targeted information to a display device where it may be viewed by the user;
wherein the remote service provider selects the targeted information in accordance with said personal information database of information related to the user.

2. A system as in claim 1 further comprising:
a second input element operable to receive a broadcast television signal; and
a channel selection element, operably coupled to said multimedia storage element and to said second input element, configured to select between a broadcast television channel and an output from said multimedia storage element;
wherein an output from said channel selection element is transmitted via said second output element to a display device.

3. A system as in claim 1, wherein said first input element and said first output element are combined in a bidirectional communications port.

4. A system as in claim 2, wherein said first and second input elements are combined.

5. A system as in claim 2, wherein said first and second input elements and said first output element are combined in a bidirectional communications port.

6. A system as in claim 5, wherein said bidirectional communications port is a cable modem.

7. A system as in claim 1 and further comprising:
a third input element for receiving a plurality of signals from a user input device;
wherein said personal information database is updated according to said plurality of signals from the user input device.

8. A system as in claim 2, wherein said system is incorporated into a set-top box.

9. A system as in claim 8, wherein said set-top box includes a web browser and said personal information database is updated by the user in response to a questionnaire displayed by said web browser.

10. A system as in claim 8, wherein said set-top box has a unique Internet protocol (IP) address, whereby the service provider may request transmission of said personal information database via the Internet.

11. A system as in claim 1, wherein said multimedia storage device is a hard disc drive.

12. A system as in claim 1, wherein said multimedia storage device is a video recorder.

13. A method for a service provider to distribute targeted information to a user's set-top box and thereby to a visual display unit for viewing by a user, said method comprising:
storing a first personal information database, accessible to the service provider, said first personal information database including information related to one or more of the user's interests, specific requests, and financial information;
selecting the targeted information according to the information in said first personal information database; and
transmitting the targeted information to the user's set-top box over a first communications link.

14. A method as in claim 13 and further comprising:
uploading a second personal information database from the user's set-top box to the service provider over a second communications link; and
updating said first personal information database according to data contained in said second personal information database;
wherein said second personal information database originates from the user.

15. A method as in claim 13 and further comprising:
identifying one or more target vendors according to information in said first personal information database;
transmitting requests for information to said one or more target vendors;
receiving targeted information from said one or more target vendors; and
transmitting said targeted information to the user's set-top box.

16. A method as in claim 13 and further comprising:
providing a database of information related to said first personal information database;
providing access to said database to said one or more target vendors via the Internet;
receiving targeted information from said one or more target vendors; and
transmitting said targeted information to the user's set-top box.

17. A method as in claim 13, further comprising:
withholding an identity of the user corresponding to the first personal information database to ensure the privacy of the user.

18. A method as in claim 13, wherein said targeted information includes one or more of a video clip, an audio clip, a custom web page and a URL link.

19. A method as in claim 13 and further comprising:
transmitting a plurality of broadcast television channels to the set-top box;
uploading, over a second communications link to the set-top box, information related to a viewing history of the user; and
updating said first personal information database in accordance with said information related to the viewing history of the user.

20. A method as in claim 13, wherein said targeted information includes one or more video advertisements.

21. A method as in claim 15, wherein said service provider acts as an agent for said targeted vendors and further comprising:
updating said first personal information database according to a purchasing history of the user.

22. A method as in claim 16, wherein said service provider acts as an agent for said targeted vendors and further comprising:
updating said first personal information database according to a purchasing history of the user.
